(19) United States
(12) Patent Application Publication
(10) Pub. No.: US 2011/0185435 A1
(43) Pub. Date: Jul. 28, 2011

(54) FLASH MEMORY STORAGE SYSTEM, AND CONTROLLER AND ANTI-FALSIFYING METHOD THEREOF

(75) Inventor: Ching-Wen Chang, Hsinchu City (TW)

(73) Assignee: PHISON ELECTRONICS CORP., Miaoli (TW)

(21) Appl. No.: 12/718,209

(22) Filed: Mar. 5, 2010

(30) Foreign Application Priority Data
Jan. 28, 2010 (TW) 99102422

(51) Int. Cl. G06F 12/14; G06F 12/02

(52) U.S. Cl. 726/27; 711/103; 711/163; 711/E12.008; 711/E12.091

(57) ABSTRACT

A flash memory storage system having a flash memory controller, a flash memory chip and a smart card chip is provided. The flash memory chip is configured to store security data. The flash memory controller generates a signature corresponding to the security data according to, a private key and the security data with a one-way hash function, and stores the signature into the smart card chip.

### CROSS-REFERENCE TO RELATED APPLICATION

This application claims the priority benefit of Taiwan application serial no. 99102422, filed on Jan. 28, 2010. The entirety of the above-mentioned patent application is hereby incorporated by reference herein and made a part of this specification.

### BACKGROUND

1. Technology Field

The present invention generally relates to a flash memory storage system, and more particularly, to a flash memory storage system capable of preventing data stored in a flash memory chip from falsifying, and a flash memory controller and an anti-falsifying method thereof.

2. Description of Related Art

Along with the widespread of digital cameras, cell phones, and MP3 in recently years, the consumers' demand to storage media has increased drastically. Flash memory is one of the most adaptable memories for such battery-powered portable products due to its characteristics such as data non-volatility, low power consumption, small volume, and non-mechanical structure. A memory card is a storage device adopting NAND flash memory as storage medium. A memory card has been broadly used for storing important personal data thanks to its small volume and large capacity. However, data stored in a memory card is easy to be changed without authorizations. That is, the integrality of data stored in a memory card can not be guaranteed.

To solve this problem, one approach is to encrypt data stored in a memory card. For example, data stored in a memory card is encoded with a digital signature. However, this approach cannot ward off a falsifying which is achieved by copying entire data in a flash memory chip. For example, in a case where a memory card is used as a paying tool (e.g., a pre-pay card) for business behavior, when a user deposits 1000 dollars in the memory card and shops by the memory card, because a flash memory chip of the memory card is an independent circuit, an attacker may identify the position of the flash memory chip, and hard-copies data stored in the flash memory chip before shopping and re-stores the hard-copied data into the flash memory chip after shopping, thereby refreshing the deposited dollars. In the foregoing hard-copy operation, because a digital signature corresponding to original data is re-stored into the memory card, the system can not verify whether data stored in the memory card is falsified by the digital signature. Thereof, how to ensure the security and the integrality of data stored in a memory card is one of the major subjects in the industry.

Nothing herein should be construed as an admission of knowledge in the prior art of any portion of the present invention. Furthermore, citation or identification of any document in this application is not an admission that such document is available as prior art to the present invention, or that any reference forms a part of the common general knowledge in the art.

### SUMMARY

The present invention is directed to a flash memory storage system capable of effectively preventing data stored in a flash memory chip from falsifying.

The present invention is directed to a flash memory controller capable of effectively preventing data stored in a flash memory chip from falsifying.

The present invention is directed to an anti-falsifying method, capable of effectively preventing data stored in a flash memory chip from falsifying.

According to an exemplary embodiment of the present invention, a flash memory storage system including a flash memory controller, a flash memory chip and a smart card chip is proposed. The flash memory controller has a private key. The flash memory chip is coupled to the flash memory controller, wherein security data is stored in the flash memory chip. The smart card chip is coupled to the flash memory controller. The flash memory controller generates a signature corresponding to the security data according to the private key and the security data with a one-way hash function, and stores the signature in the smart card chip.

According to an exemplary embodiment of the present invention, a flash memory storage system including a flash memory controller, a flash memory chip and a smart card chip is proposed. The flash memory controller has a private key. The flash memory chip is coupled to the flash memory controller, wherein security data is stored in the flash memory chip. The smart card chip is coupled to the flash memory controller. The flash memory controller generates an eigenvalue corresponding to the security data and stores the eigenvalue in the smart card chip. Additionally, the flash memory controller generates a signature corresponding to the security data and the eigenvalue according to the private key, the eigenvalue and the security data with a one-way hash function, and stores the signature in the flash memory chip.

According to an exemplary embodiment of the present invention, a flash memory controller for protecting security data stored in a flash memory chip is proposed. The flash memory controller includes a microprocessor unit, a flash memory interface unit, a memory management unit and a security data protection unit. The flash memory interface unit is coupled to the microprocessor unit and configured to couple to the flash memory chip. The memory management unit is coupled to the microprocessor unit. The security data protection unit is coupled to the microprocessor unit and has a private key. The security data protection unit generates a signature corresponding to the security data according to the private key and the security data with a one-way hash function, and stores the signature in the smart card chip.

According to an exemplary embodiment of the present invention, a flash memory controller for protecting security data stored in a flash memory chip is proposed. The flash memory controller includes a microprocessor unit, a flash memory interface unit, a memory management unit and a security data protection unit. The flash memory interface unit is coupled to the microprocessor unit and configured to couple to the flash memory chip. The memory management unit is coupled to the microprocessor unit. The security data protection unit is coupled to the microprocessor unit and has a private key. The security data protection unit generates an eigenvalue corresponding to the security data and stores the eigenvalue in the smart card chip. The security data protection unit generates a signature corresponding to the security data and the eigenvalue according to the private key, the eigenvalue and the security data with a one-way hash function, and stores the signature in the flash memory chip.

According to an exemplary embodiment of the present invention, an anti-falsifying method for protecting security data stored in a flash memory chip of a flash memory storage system is proposed. The anti-falsifying method comprises: disposing a smart card chip in a flash memory storage system; generating a signature corresponding to the security data according to a private key and the security data with a one-way hash function; and storing the signature in the smart card chip.

According to an exemplary embodiment of the present invention, an anti-falsifying method for protecting security data stored in a flash memory chip of a flash memory storage system is proposed. The anti-falsifying method comprises: disposing a smart card chip in a flash memory storage system; generating an eigenvalue corresponding to the security data; and storing the eigenvalue in the smart card chip. The anti-falsifying method also comprises: generating a signature corresponding to the security data and the eigenvalue according to a private key, the eigenvalue and the security data with a one-way hash function; and storing the signature in the flash memory chip.

As described above, the flash memory storage system, the controller and the anti-falsifying method can effectively ensure the integrality of the security data by storing the signature or the eigenvalue corresponding to the security data in the smart card chip and verifying whether the security data is falsified according to the stored signature or the stored eigenvalue when the security data is read from the flash memory chip.

It should be understood, however, that this Summary may not contain all of the aspects and embodiments of the present invention, is not meant to be limiting or restrictive in any manner, and that the invention as disclosed herein is and will be understood by those of ordinary skill in the art to encompass obvious improvements and modifications thereto.

In order to make the aforementioned and other features and advantages of the invention more comprehensible, embodiments accompanying figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a schematic block diagram of a host system using a flash memory storage apparatus according to a first exemplary embodiment of the present invention.

FIG. 1B is a diagram illustrating a computer, an input/output (I/O) device, and a flash memory storage apparatus according to an exemplary embodiment of the present invention.

FIG. 1C is a diagram of a host system and a flash memory storage apparatus according to another exemplary embodiment of the present invention.

FIG. 2 is a schematic block diagram of the flash memory storage apparatus in FIG. 1A.

FIG. 3A is a schematic block diagram of a smart card chip according to the first exemplary embodiment of the present invention.

FIG. 3B is a schematic block diagram of a flash memory controller according to the first exemplary embodiment of the present invention.

FIG. 4 is a diagram illustrating an example of verifying the integrality of security data according to the first exemplary embodiment of the present invention.

FIG. 5 is a diagram illustrating another example of verifying the integrality of security data according to the first exemplary embodiment of the present invention.

FIG. 6 is a flowchart illustrating an anti-falsifying method according to the first exemplary embodiment of the present invention.

FIG. 7 is a schematic block diagram illustrating a flash memory storage apparatus according to a second exemplary embodiment of the present invention.

FIG. 8 is a diagram illustrating an example of verifying the integrality of security data according to the second exemplary embodiment of the present invention.

FIG. 9 is a diagram illustrating another example of verifying the integrality of security data according to the second exemplary embodiment of the present invention.

FIG. 10 is a flowchart illustrating an anti-falsifying method according to the second exemplary embodiment of the present invention.

### DESCRIPTION OF EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

Embodiments of the present invention may comprise any one or more of the novel features described herein, including in the Detailed Description, and/or shown in the drawings. As used herein, “at least one”, “one or more”, and “and/or” are open-ended expressions that are both conjunctive and disjunctive in operation. For example, each of the expressions “at least on of A,B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

It is to be noted that the term “a” or “an” entity refers to one or more of that entity. As such, the terms “a” (or “an”), “one or more” and “at least one” can be used interchangeably herein.

A flash memory storage apparatus (i.e., a flash memory storage system), typically, includes a flash memory chip and a controller (i.e., a control circuit). The flash memory storage apparatus is usually used together with a host system so that the host system can write data into or read data from the flash memory storage apparatus. In addition, a flash memory storage apparatus also includes an embedded flash memory and a software that can be executed by a host system and substantially served as a controller of the embedded flash memory.

### First Exemplary Embodiment

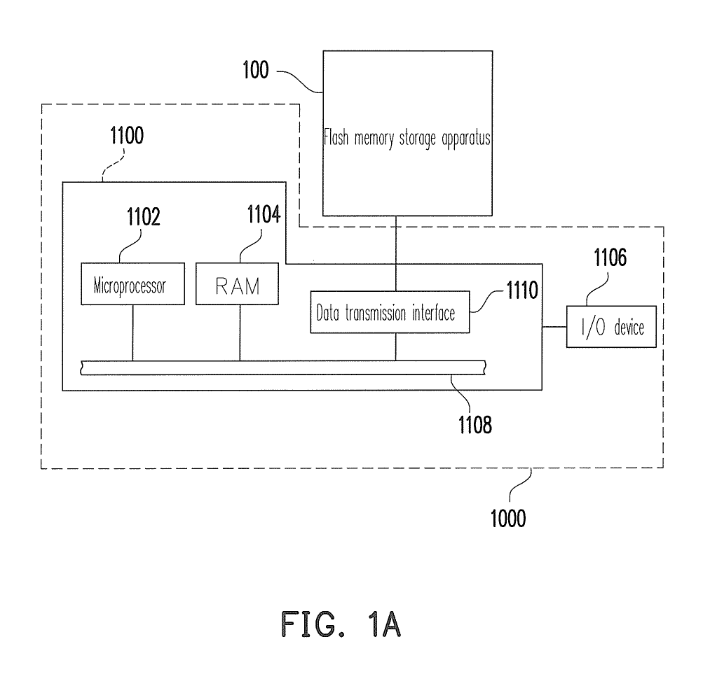

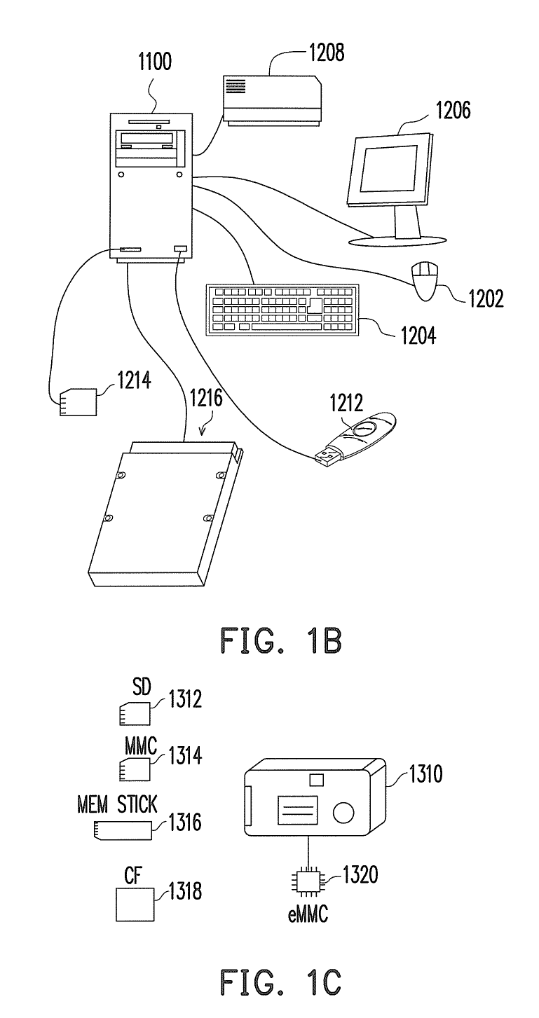

FIG. 1A is a schematic block diagram of a host system using a flash memory storage apparatus according to a first exemplary embodiment of the present invention. Referring to FIG. 1A, a host system 1000 includes a computer 1100 and an input/output (I/O) device 1106. The computer 1100 includes a microprocessor 1102, a random access memory (RAM) 1104, a system bus 1108, and a data transmission interface 1110. The I/O device 1106 includes a mouse 1202, a keyboard 1204, a display 1206, and a printer 1208, as shown in FIG. 1B. It should be understood that the devices illustrated in FIG. 1B are not intended to limit the scope of the I/O device 1106, and the I/O device 1106 may further include other devices.

In the exemplary embodiment of the present invention, the flash memory storage apparatus 100 is coupled to the devices of the host system 1000 through the data transmission interface 1110. By using the microprocessor 1102, the random access memory (RAM) 1104 and the Input/Output (I/O) device 1106, the data can be write into the flash memory storage apparatus 100 or can be read from the flash memory storage apparatus 100. The flash memory storage apparatus 100 may be a flash drive 1212, a memory card 1214, or a solid state drive (SSD) 1216, as shown in FIG. 1B.

Generally, the host system 1000 substantially can be any system capable of storing data. Even though the host system 1000 is described as a computer system in the exemplary embodiment, in another exemplary embodiment of the present invention, the host system 1000 may also be a digital camera, a video camera, a communication device, an audio player, or a video player, and etc. For example, if the host system is a digital camera (video camera) 1310, the flash memory storage device is then a SD card 1312, a MMC card 1314, a memory stick 1316, a CF card 1318 or an embedded storage device 1320 (as shown in FIG. 1C). The embedded storage device 1320 includes an embedded MMC (eMMC). It should be mentioned that the eMMC is directly coupled to a substrate of the host system 1000.

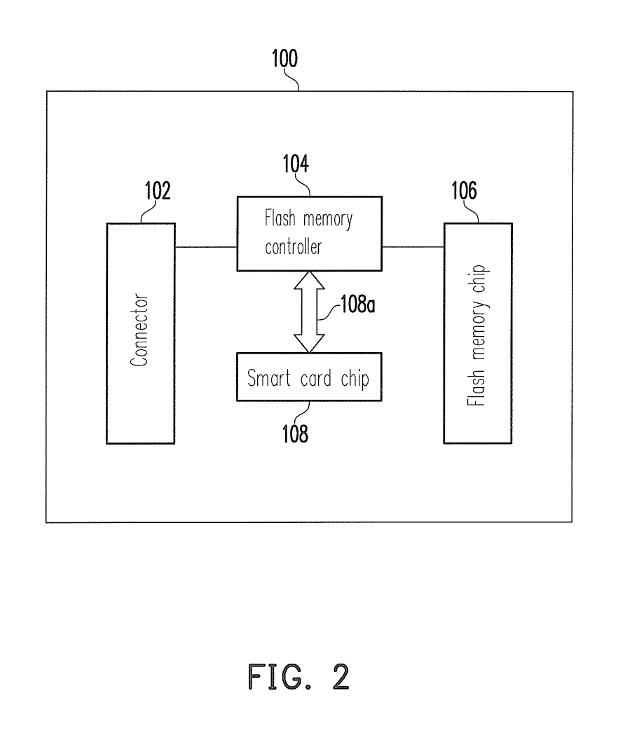

FIG. 2 is a schematic block diagram of the flash memory storage apparatus in FIG. 1A.

Referring to FIG. 2, the flash memory storage apparatus 100 includes a connector 102, a flash memory controller 104, a flash memory chip 106 and a smart cart chip 108.

The connector 102 is coupled to the flash memory controller 104 and configured for coupling to the host system 1000. In the present exemplary embodiment, the connector 102 is a secure digital (SD) interface connector. However, it should be noticed that the present invention is not limited to the aforementioned description and the connector 102 also can be a Serial Advanced Technology Attachment (SATA) connector, a Parallel Advanced Technology Attachment (PATA) connector, a universal serial bus (USB) connector, an institute-of-electrical-and-electronic-engineers (IEEE) 1394 connector, a peripheral-component Interconnect-express (PCI Express) connector, a memory stick (MS) interface connector, a multi-media-card (MMC) interface connector, a compact flash (CF) interface connector, an integrated-device-electronics (IDE) connector or other suitable type of connectors.

The flash memory controller 104 executes a plurality of logic gates or control instructions implemented in a hardware form or a firmware form and performs various data operations such as data writing, reading, and erasing in the flash memory chip 106 according to commands of the host system 1000. In particular, the flash memory controller 104 performs an anti-falsifying mechanism for preventing data stored in the flash memory chip 106 from falsifying.

The flash memory chip 106 is coupled to the flash memory controller 104 and has a plurality of physical blocks for storing data. For example, in the present exemplary embodiment, the flash memory controller 104 groups the physical blocks of the flash memory chip 106 into a general data storage area and a security data storage area. And, the flash memory controller 104 performs is the anti-falsifying mechanism to data stored in the security data storage area, thereby preventing data needed to be protected from changing by an attacker.

In the present exemplary embodiment, the flash memory chip 106 is a multi level cell (MLC) NAND flash memory chip. However, the present invention is not limited thereto, and the flash memory chip 106 may also be a single level cell (SLC) NAND flash memory chip.

The smart card chip 108 is coupled to the flash memory controller 104 and is configured to store data and encrypt/decrypt the stored data.

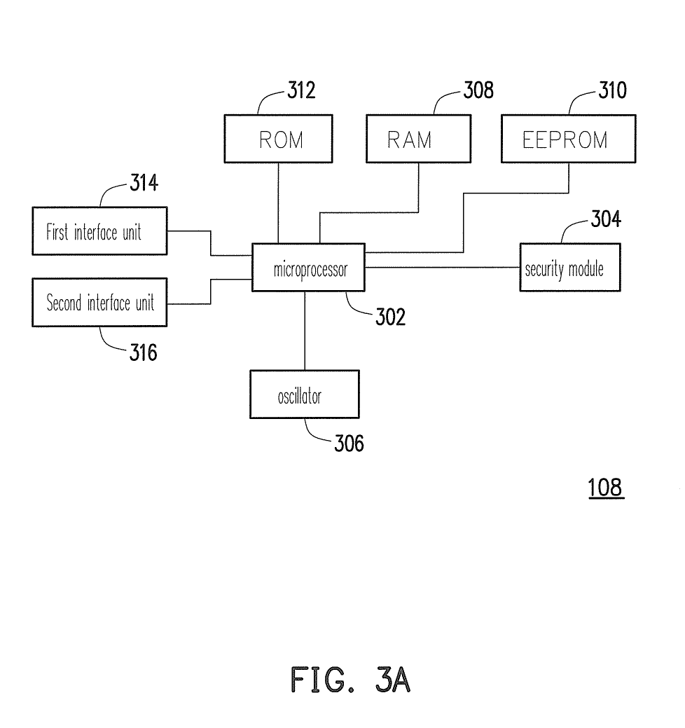

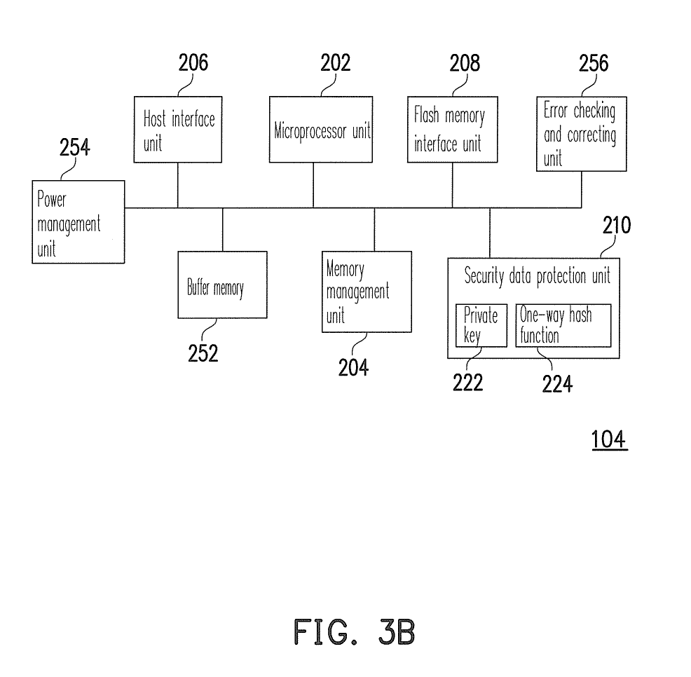

FIG. 3A is a schematic block diagram of a smart card chip according to the first exemplary embodiment of the present invention.

The smart card chip 108 has a microprocessor 302, a security module 304, an oscillator 306, a random access memory (RAM) 308, an electrically erasable programmable read-only memory (EEPROM) 310, a read only memory (ROM) 312, a first interface unit 314 and a second interface unit 316.

The microprocessor 302 is used for controlling the whole operation of the smart card chip 108. The security module 304 is used for encrypting/decrypting data stored in the smart card chip 108. The oscillator 306 is used for generating clock signals needed for the operation of the smart card chip 108.

The random access memory 308 is used for temporarily storing data or firmware codes. The electrically erasable programmable read-only memory 310 is used for storing user data. The read only memory 312 is used for storing the firmware codes of the smart card chip 108. To be specific, when the smart card chip 108 is operated, the microprocessor 302 executes the firmware codes in the read only memory 312 to perform related operations.

The first interface unit 314 is used for coupling to the flash memory controller 104. For example, the first interface unit is an interface complied with ISO 7816 standards. The second interface unit 316 is used for coupling to a radio frequency antenna to receive a radio frequency signal. For example, the second interface unit is an interface complied with ISO 14443 standards.

In particular, the security module 304 of the smart card chip 108 may perform a security mechanism for preventing an attack of stealing data stored in the smart card chip 108. For example, the attack may be a timing attack, a single-power-analysis attack or a differential-power-analysis. Additionally, the security mechanism performed by the smart card chip 108 complies with a third or higher level of Federal Information Processing Standards (FIPS) 140-2 or a third or higher level of EMV EL. That is, the smart card chip 108 passes the certification of the third or higher level of FIPS 140-2 or the third or higher level of EMV EL. Herein, FIPS is an open standard that is made by American Federal Government for government organizations and contractors thereof, besides military organizations. Additionally, EMV is a standard which is made by international finance industries for smart cards, terminals of point-of-sales which can identify chip cards, and automatic teller machines. This standard is established for hardware and software equipments of a payment system aiming at chip credit cards and cash cards. In the present exemplary embodiment, the flash memory controller 104 stores information for verifying whether data stored in the flash memory chip 106 has be falsified, thereby preventing data stored in the flash memory chip 106 from falsifying.

FIG. 3B is a schematic block diagram of a flash memory controller according to the first exemplary embodiment of the present invention.

Referring to FIG. 3B, the flash memory controller 104 includes a microprocessor unit 202, a memory management unit 204, a host interface unit 206, a flash memory interface unit 208 and a security data protection unit 210.

The microprocessor unit 202 is the main control unit of the flash memory controller 104, and cooperates with the memory management unit 204, the host interface unit 206, the flash memory interface unit 208 and the security data protection unit 210 to carry out various operations of the flash memory storage apparatus 100.

The memory management unit 204 is coupled to the microprocessor unit 202 and configured for performing a data access mechanism and a flash memory management mechanism. For example, the memory management unit 204 maintains a logical address-physical address mapping table to manage mapping relationships between the logical addresses and the physical addresses. Additionally, the memory management unit 204 receives write commands or read commands from the host system 1000 and accesses data at physical addresses mapped to logical addresses to be accessed by the host system based on the information recorded in the logical address-physical address mapping table.

The host interface unit 206 is coupled to the microprocessor unit 202, and configured for receiving and identifying commands and data from the host system 1000. Namely, the commands and data from the host system 1000 are transmitted to the microprocessor unit 202 through the host interface unit 206. In the exemplary embodiment, the host interface unit 206 is a SD interface corresponding to the connector 102. However, it should be understood that the invention is not limited thereto, and the host interface unit 206 can be a SATA interface, a PATA interface, a USB interface, an IEEE 1394 interface, a PCI express interface, a MS interface, a MMC interface, a CF interface, an IDE interface, or other suitable data transmission interfaces.

The flash memory interface unit 208 is coupled to the microprocessor unit 202 and configured for accessing the flash memory chip 106. Namely, data to be written into the flash memory chip 106 is converted by the flash memory interface unit 208 into a format acceptable to the flash memory chip 106.

The security data protection unit 210 is coupled to the microprocessor unit 202 and is configured to perform the anti-falsifying mechanism according to the present exemplary embodiment. In the present exemplary embodiment, a private key 222 and a one-way hash function 224 are established in the security data protection unit 210. For example, during the flash memory controller 104 is manufactured, the private key 222 is randomly generated and stored in the security data protection unit 210 by the manufacturer of the flash memory controller 104 And, when the memory management unit 204 writes data need to be protected (also referred to “security data”) in the flash memory chip 106, the security data protection unit 210 generates a signature corresponding to the security data according to the private key 222 and the security data with the one-way hash function 224, and stores the generated signature into the smart card chip 108. For example, the memory management unit 204 stores the generated signature into the EEPROM 310 of the smart card chip 108 through an application protocol data unit (APDU), or read the signature from the EEPROM 310 of the smart card chip 108 through the APDU.

In the present exemplary embodiment, the one-way hash function 224 is implemented with SHA-256. However, it should be understood that the present invention is not limited thereto, and in another exemplary embodiment the one-way hash function 224 may be implemented with MD5, RIPEMD-160 SHA1, SHA-386, SHA-512 or other suitable functions.

In the present exemplary embodiment, when the memory management unit 204 reads security data, which is written previously, from the flash memory chip 106, the security data protection unit 210 reads the corresponding signature from the smart card chip 108 and generates a comparison signature corresponding to the read security data according to the private key 222 and the read security data with the one-way hash function 224. In particular, the security data protection unit 210 determines whether the read security data has been falsified according to the read signature and the comparison signature.

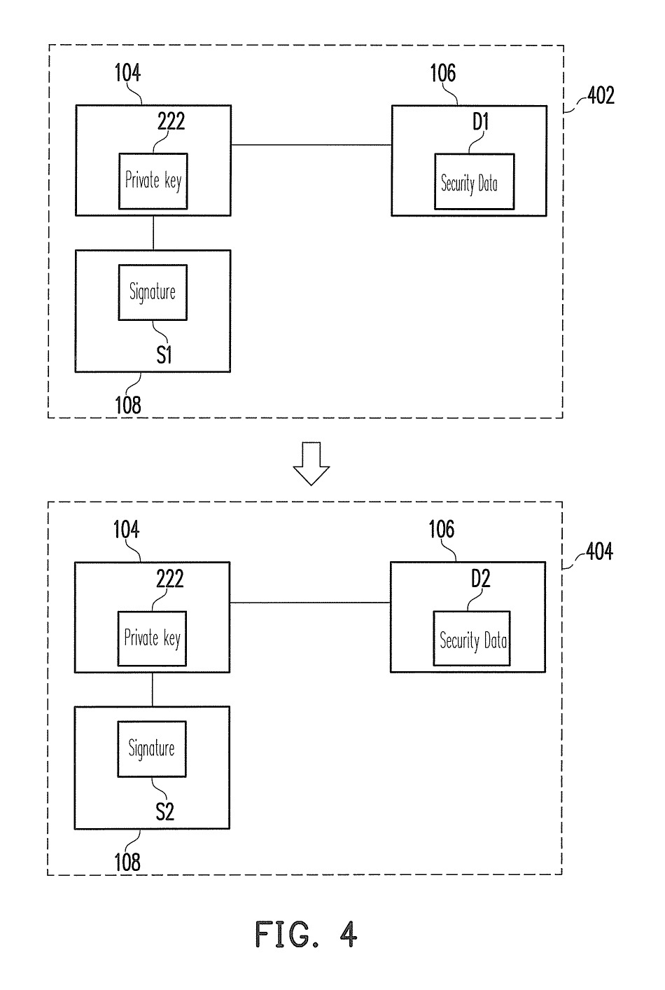

FIG. 4 is a diagram illustrating an example of verifying the integrality of security data according to the first exemplary embodiment of the present invention.

Referring to FIG. 4, as a status 402, when the memory management unit 204 writes security data D1 into the flash memory chip 106, the security data protection unit 210 uses the private key 224 and the security data D1 as input parameters of the one-way hash function 224 to generate a signature S1 corresponding to the security data D1. Additionally, the security data protection unit 210 stores the signature S1 into the smart card chip 108.

As a status 404, when the memory management unit 204 writes security data D2 into the flash memory chip 106 for replacing the security data D1, the security data protection unit 210 uses the private key 222 and the security data D2 as input parameters of the one-way hash function 224 to generate a signature S2 corresponding to the security data D2. Additionally, the security data protection unit 210 stores the signature S2 into the smart card chip 108 for replacing the signature S1.

In particular, at this time, if the memory management unit 204 receives a read command and reads security data from the flash memory chip 106, the memory management unit 204 correctly reads the security data D2. Meanwhile, the security data protection unit 210 uses the private key 222 and the security data D2 read by the memory management unit 204 as input parameters of the one-way hash function 224 to generate a comparison signature CS1 corresponding to the read security data D2. In this example, because the input parameters for generating the signature S2 is the same as the input parameters for generating the comparison signature CS1, the comparison signature CS1 certainly is identical to the signature S2 stored in the smart card chip 108. Accordingly, the security data protection unit 210 verifies that the read security data is intact.

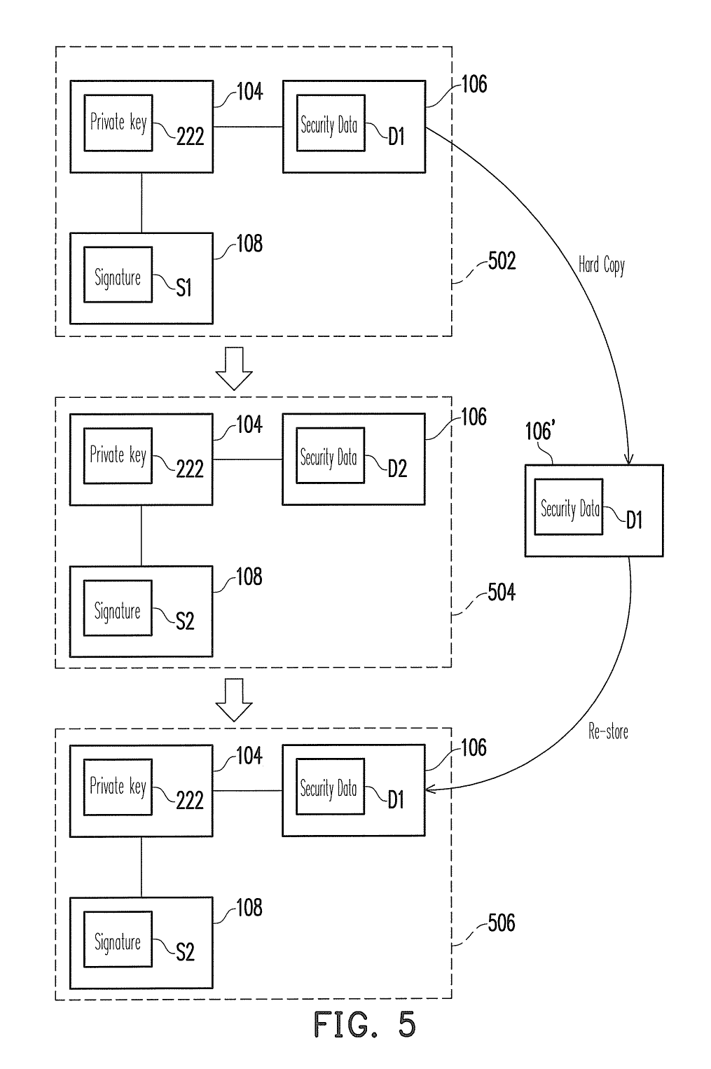

FIG. 5 is a diagram illustrating another example of verifying the integrality of security data according to the first exemplary embodiment of the present invention.

Referring to FIG. 5, as a status 502, when the memory management unit 204 writes the security data D1 into the flash memory chip 106, the security data protection unit 210 uses the private key 224 and the security data D1 as input parameters of the one-way hash function 224 to generate the signature S1 corresponding to the security data D1. Additionally, the security data protection unit 210 stores the signature S1 into the smart card chip 108. In particular, at this time, an un-authorization user uses a hard copy mechanism to copy entire data stored in the flash memory chip 106 to a backup flash memory chip 106′.

As a status 504, when the memory management unit 204 writes security data D2 into the flash memory chip 106 for replacing the security data D1, the security data protection unit 210 uses the private key 222 and the security data D2 as input parameters of the one-way hash function 224 to generate the signature S2 corresponding to the security data D2. Additionally, the security data protection unit 210 stores the signature S2 into the smart card chip 108 for replacing the signature S1. In particular, at this time, the un-authorization user re-stores the data in the backup flash memory chip 106′ into the flash memory chip 106, as shown in a status 506.

Under the status 506, if the memory management unit 204 receives a read command and reads security data from the flash memory chip 106, the memory management unit 204 wrongly reads the security data D1 because the security data D2 has been falsified as the security data D1. Meanwhile, the security data protection unit 210 uses the private key 222 and the security data D1 read by the memory management unit 204 as input parameters of the one-way hash function 224 to generate a comparison signature CS2 corresponding to the security data D1. In this example, because the security data D2 has been falsified as the security data D1, the generated comparison signature CS2 certainly is not identical to the signature S2 stored in the smart card chip 108. Accordingly, the security data protection unit 210 verifies that the read security data has been falsified, and outputs a warning message.

In the foregoing example, the security data protection unit 210 generates a signature for security data to be stored in the flash memory chip 106 and stores the generated signature into the smart card chip 108. Because data stored in the smart card chip 108 is difficult to be falsified, the integrality of the security data can be verified by the signature stored in the smart card chip 108.

It should be noted that in the present exemplary embodiment, the storing, the updating and the verifying of security data are explained by taking single security data as an example. However, the invention is not limited thereto, in another exemplary embodiment, when the memory management unit 204 stores a plurality of security data in the flash memory chip 106, the security data protection unit 210 may generate a corresponding signature for each security data and store the signatures in the smart card chip 108 for verifying the integrality of each security data. Additionally, in another exemplary embodiment, when the memory management unit 204 stores a plurality of security data in the flash memory chip 106, the security data protection unit 210 may generate one signature for all the security data and store the signature in the smart card chip 108 for verifying the integrality of the security data.

In the present exemplary embodiment, the memory management unit 204 and the security data protection unit 210 are implemented in the flash memory controller 104 in a firmware form. For example, the memory management unit 204 and the security data protection unit 210 including a plurality of control instructions is burned into a program memory (for example, a read only memory (ROM)), and the program memory is embedded into the flash memory controller 104. When the flash memory storage apparatus 100 is in operation, the control instructions of the memory management unit 204 are executed by the microprocessor unit 202 to accomplish the data access mechanism and the flash memory management mechanism according to the present exemplary embodiment, and the control instructions of the security data protection unit 210 are executed by the microprocessor unit 202 to accomplish the anti-falsifying mechanism according to the present exemplary embodiment.

In another exemplary embodiment of the present invention, the control instructions of the memory management unit 204 and the security data protection unit 210 may be stored in a specific area (for example, the system area of a flash memory chip exclusively used for storing system data) of the flash memory chip 106 as program codes. Similarly, the control commands of the memory management unit 204 and the security data protection unit 210 are executed by the microprocessor unit 202 when the flash memory storage apparatus 100 is in operation. In addition, in yet another exemplary embodiment of the present invention, the memory management unit 204 and the security data protection unit 210 may also be implemented in the flash memory controller 104 in a hardware form.

Referring to 3B, for example, the flash memory controller 104 further includes a buffer memory 252, a power management unit 254, and an error checking and correcting unit 256.

The buffer memory 252 is coupled to the microprocessor unit 202 and configured to temporarily store data and commands from the host system 1000 or data from the flash memory chip 106.

The power management unit 254 is coupled to the microprocessor unit 202, and configured to control the power supply of the flash memory storage apparatus 100.

The error checking and correcting unit 256 is coupled to the microprocessor unit 202, and configured for executing an error checking and correcting procedure to ensure data accuracy. To be specific, when the memory management unit 204 receives a write command from the host system 1000, the error checking and correcting unit 256 generates an error checking and correcting (ECC) code for the data corresponding to the write command, and the memory management unit 204 writes the data and the corresponding ECC code into the flash memory chip 106. Subsequently, when the memory management unit 204 reads the data from the flash memory chip 106, the memory management unit 204 simultaneously reads the corresponding ECC code, and the error checking and correcting unit 256 executes the ECC procedure for the read data based on the ECC code corresponding to the read data.

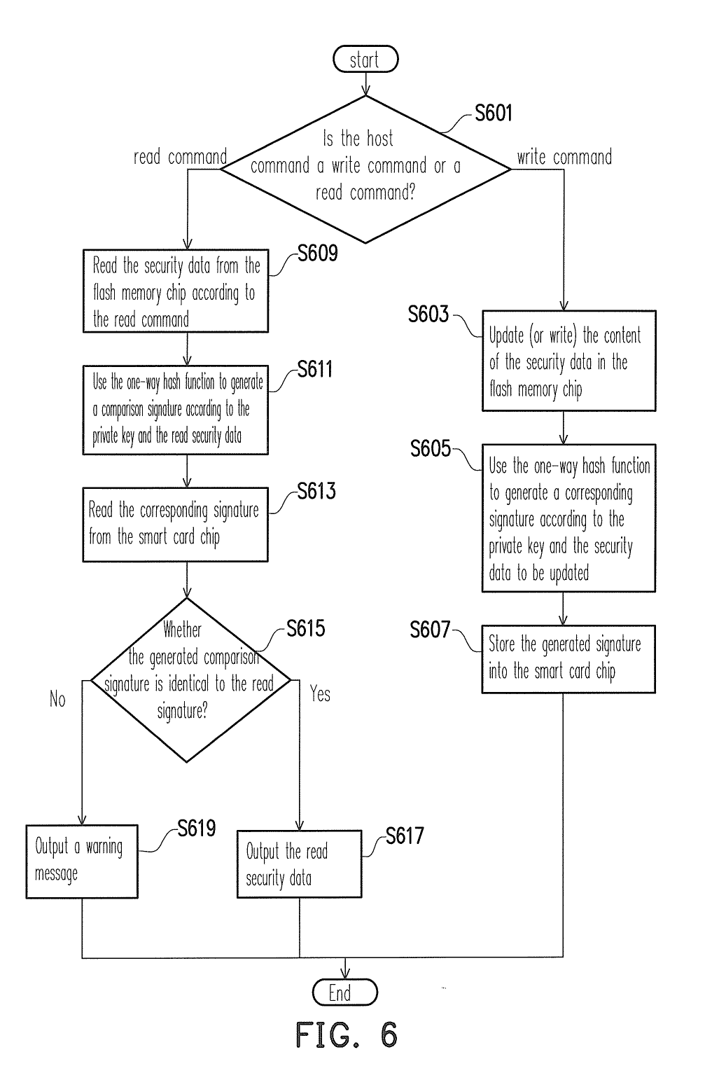

FIG. 6 is a flowchart illustrating an anti-falsifying method according to the first exemplary embodiment of the present invention.

Referring to FIG. 6, when a host command for accessing security data is received, in step S601, the memory management unit 204 determines whether the host command is a write command or a read command.

When the received host command is the write command, then in step S603, the memory management unit 204 updates (or writes) the content of the security data in the flash memory chip 106. To be specific, when the flash memory storage apparatus 100 receives the write command for updating the security data, the memory management unit 204 writes the security data into the flash memory chip 106 according to the information recorded at the logical address-physical address mapping table.

After that, in step S605, the security data protection unit 210 uses the one-way hash function 224 to generate a corresponding signature according to the private key 222 and the security data to be updated. Then, in step S607, the security data protection unit 210 stores the generated signature into the smart card chip 108.

When the received host command is the read command, then in step S609, the memory management unit 204 reads the security data from the flash memory chip 106 according to the read command.

After that, in step S611, the security data protection unit 210 uses the one-way hash function 224 to generate a comparison signature according to the private key 222 and the read security data. And, in step S613, the security data protection unit 210 reads the corresponding signature from the smart card chip 108.

Then, in step S615, the security data protection unit 210 determines whether the generated comparison signature is identical to the read signature. If the generated comparison signature is identical to the read signature, then in step S617, the memory management unit 204 outputs the read security data to the host system 1000. On the contrary, if the generated comparison signature is not identical to the read signature, then in step S619, the security data protection unit 210 outputs a warning message to the host system 1000, thereby notifying that the security data has been falsified.

### Second Exemplary Embodiment

A flash memory storage apparatus and a host system in the second exemplary embodiment essentially are similar to the flash memory storage apparatus and the host system in the first exemplary embodiment, wherein the difference is that when a memory management unit updates security data, a security data protection unit stores an eigenvalue corresponding to the updated security data into a smart card chip and verifies the integrality of the security data based on the stored eigenvalue in the second exemplary embodiment.

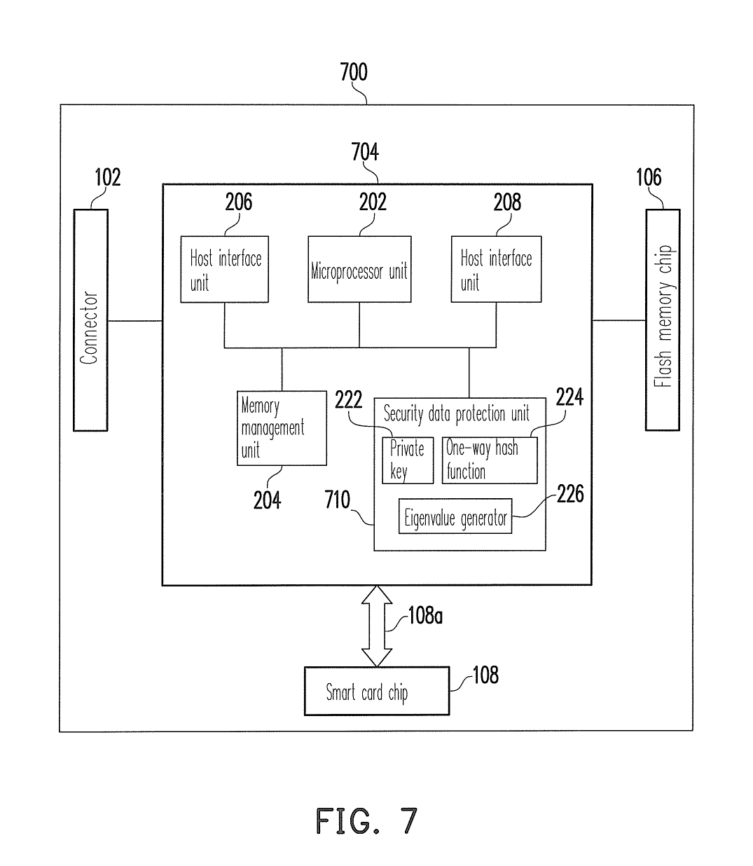

FIG. 7 is a schematic block diagram illustrating a flash memory storage apparatus according to a second exemplary embodiment of the present invention. Referring to FIG. 7, the flash memory storage apparatus 700 is coupled to other devices of the host system 1000 through the data transmission interface 1110. By using the microprocessor 1102, the random access memory (RAM) 1104 and the Input/Output (I/O) device 1106, the data can be write into the flash memory storage apparatus 700 or can be read from the flash memory storage apparatus 700. The flash memory storage apparatus 700 may be a flash drive 1212, a memory card 1214, or a solid state drive (SSD) 1216, as shown in FIG. 1B.

The flash memory storage apparatus 700 includes the connector 102, a flash memory controller 704, the flash memory chip 106 and the smart cart chip 108.

The connector 102, the flash memory chip 106 and the smart cart chip 108 are coupled to the flash memory controller 704, wherein the smart card chip 108 is coupled to the flash memory controller 704 via the interface 108a. The structures and functionality of the connector 102, the flash memory chip 106 and the smart cart chip 108 have been described as above, so they will not be repeated here.

The flash memory controller 704 includes the microprocessor unit 202, the memory management unit 204, the host interface unit 206, the flash memory interface unit 208 and a security data protection unit 710.

Similarly, the structures and functionality of the microprocessor unit 202, the memory management unit 204, the host interface unit 206 and the flash memory interface unit 208 have been described as above, so they will not be repeated here.

The security data protection unit 710 is coupled to the microprocessor unit 202 and is configured to perform an anti-falsifying mechanism according to the present exemplary embodiment. In the present exemplary embodiment, the private key 222, the one-way hash function 224 and an eigenvalue generator 226 are established in the security data protection unit 710.

In the exemplary embodiment, whenever the memory management unit 204 updates (or writes) security data in the flash memory chip 106, the eigenvalue generator 226 generates an eigenvalue corresponding the updated security data. For example, in the present exemplary embodiment, the eigenvalue generator 226 may use a serial number of a physical address for storing the updated security data as the eigenvalue corresponding the updated security data. To be specific, in the operation of the flash memory chip, physical addresses are alternatively used to store data written into logical addresses by the host system 1000. Once the security data is updated, the physical address for storing the security data is changed.

In addition, in another exemplary embodiment of the present invention, the eigenvalue generator 226 may generate the eigenvalue corresponding to the security data in a random mechanism. For example, whenever the memory management unit 204 updates (or writes) security data in the flash memory chip 106, the eigenvalue generator 226 randomly generates a random number as an eigenvalue corresponding the updated security data. Or, in yet another exemplary embodiment of the present invention, the eigenvalue generator 226 may orderly generate a counter value as an eigenvalue corresponding to the security data. For example, whenever the memory management unit 204 updates (or writes) security data in the flash memory chip 106, the eigenvalue generator 226 counts the counter value (e.g., the counter value is added by “1”) as an eigenvalue corresponding the updated security data.

In the present exemplary embodiment, when the memory management unit 204 writes security data need to be protected into the flash memory chip 106, the security data protection unit 710 generates a signature corresponding to the security data according to the private key 222, an eigenvalue generated by the eigenvalue generator 226 and the security data to be written with the one-way hash function 224. In particular, the security data protection unit 710 stores the generated signature in the flash memory chip 106 and stores the corresponding eigenvalue in the smart card chip 108.

In the present exemplary embodiment, when the memory management unit 204 reads security data, which is written previously, from the flash memory chip 106, the security data protection unit 710 reads the corresponding eigenvalue from the smart card chip 108, reads the corresponding signature from the flash memory chip 106, and generates a comparison signature corresponding to the read security data according to the private key 222, the read eigenvalue and the read security data with the one-way hash function 224. In particular, the security data protection unit 710 determines whether the read security data has been falsified according to the read signature and the generated comparison signature.

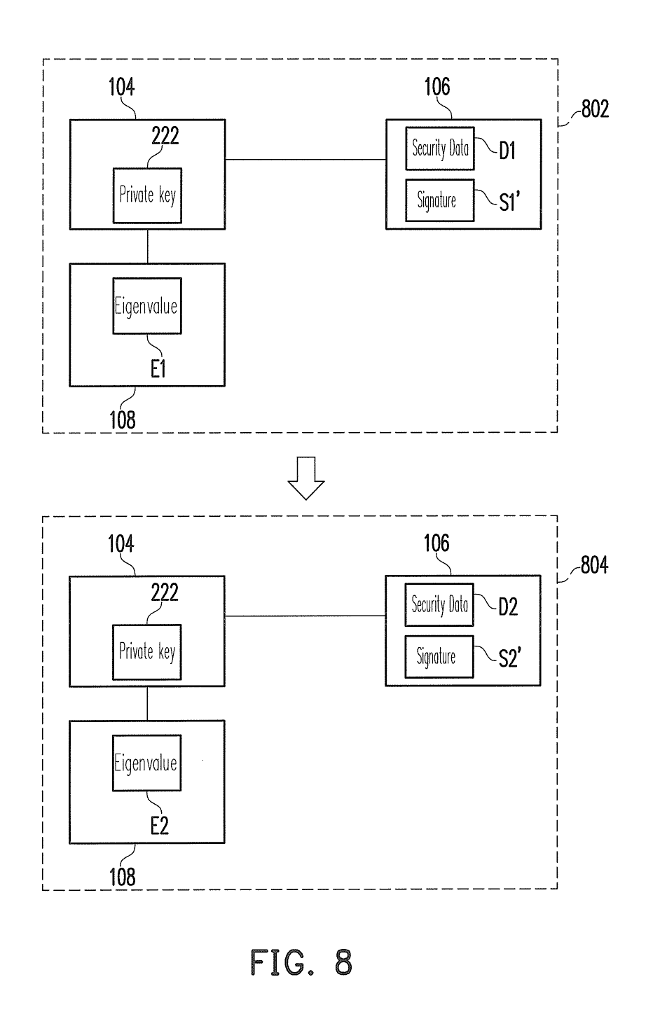

FIG. 8 is a diagram illustrating an example of verifying the integrality of security data according to the second exemplary embodiment of the present invention.

As a status 802, when the memory management unit 204 writes the security data D1 into the flash memory chip 106, the eigenvalue generator 226 generates an eigenvalue E1 corresponding to the security data D1 and the security data protection unit 710 uses the private key 222, the eigenvalue E1 and the security data D1 as input parameters of the one-way hash function 224 to generate a signature S1′ corresponding to the security data D1. Additionally, the security data protection unit 710 stores the signature S1′ in the flash memory chip 106 and stores the eigenvalue E1 in the smart card chip 108.

As a status 804, when the memory management unit 204 writes the security data D2 into the flash memory chip 106 for replacing the security data D1, the eigenvalue generator 226 generates an eigenvalue E2 corresponding to the security data D2 and the security data protection unit 710 uses the private key 222, the eigenvalue E2 and the security data D2 as input parameters of the one-way hash function 224 to generate a signature S2′ corresponding to the security data D2. Additionally, the security data protection unit 710 stores the signature S2′ in the flash memory chip 106 for replacing the signature S1′ and stores the eigenvalue E2 in the smart card chip 108 for replacing the eigenvalue E1.

At this time, if the memory management unit 204 receives a read command and reads security data from the flash memory chip 106, the memory management unit 204 correctly reads the security data D2. Meanwhile, the security data protection unit 710 reads the corresponding eigenvalue E2 from the smart card chip 108, reads the corresponding signature S2′ from the flash memory chip 106, and uses the private key 222, the eigenvalue E2 and the security data D2 read by the memory management unit 204 as input parameters of the one-way hash function 224 to generate a comparison signature CS1′ corresponding to the read security data D2. In this example, because the input parameters for generating the signature S2 is the same as the input parameters for generating the comparison signature CS1′, the comparison signature CS1′ certainly is identical to the signature S2 stored in the flash memory chip 106. Accordingly, the security data protection unit 710 verifies that the read security data is intact.

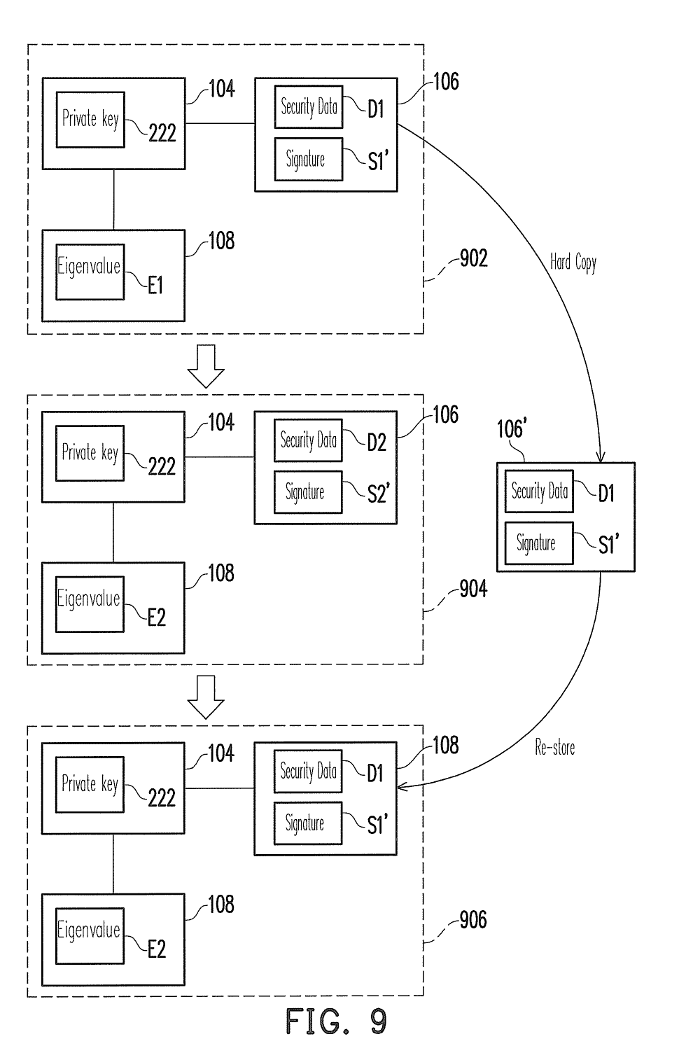

FIG. 9 is a diagram illustrating another example of verifying the integrality of security data according to the second exemplary embodiment of the present invention.

Referring to FIG. 9, as a status 902, when the memory management unit 204 writes the security data D1 into the flash memory chip 106, the eigenvalue generator 226 generates the eigenvalue E1 corresponding to the security data D1 and the security data protection unit 710 uses the private key 222, the eigenvalue E1 and the security data D1 as input parameters of the one-way hash function 224 to generate the signature S1′ corresponding to the security data D1. Additionally, the security data protection unit 710 stores the eigenvalue E1 in the smart card chip 108 and stores the signature S1′ in the flash memory chip 106. In particular, at this time, an un-authorization user uses a hard copy mechanism to copy entire data stored in the flash memory chip 106 into a backup flash memory chip 106′.

As a status 904, when the memory management unit 204 writes the security data D2 into the flash memory chip 106 for replacing the security data D1, the eigenvalue generator 226 generates the eigenvalue E2 corresponding to the security data D2 and the security data protection unit 710 uses the private key 222, the eigenvalue E2 and the security data D2 as input parameters of the one-way hash function 224 to generate the signature S2′ corresponding to the security data D2. Additionally, the security data protection unit 710 stores the signature S2′ in the flash memory chip 106 for replacing the signature S1′ and stores the eigenvalue E2 in the smart card chip 108 for replacing the eigenvalue E1. In particular, at this time, the un-authorization user re-stores the data in the backup flash memory chip 106′ into the flash memory chip 106, as shown in a status 906.

Under the status 906, if the memory management unit 204 receives a read command and reads security data from the flash memory chip 106, the memory management unit 204 wrongly reads the security data D1 because the security data D2 has been falsified as the security data D1. Meanwhile, the security data protection unit 710 reads the corresponding eigenvalue E2 from the smart card chip 108, reads the signature S1′ from the flash memory chip 106, and uses the private key 222, the eigenvalue E2 and the security data D1 read by the memory management unit 204 as input parameters of the one-way hash function 224 to generate a comparison signature CS2′ corresponding to the security data D1. In this example, because the security data D2 has been falsified as the security data D1, the comparison signature CS2′ generated based on the eigenvalue E2 certainly is not identical to the signature S1′ stored in the smart card chip 106. Accordingly, the security data protection unit 710 verifies that the read security data has been falsified, and outputs a warning message.

In the foregoing example, the security data protection unit 710 generates an eigenvalue for security data to be stored in the flash memory chip 106 and stores the generated eigenvalue into the smart card chip 108. Data stored in the smart card chip 108 is difficult to falsify, therefore the integrality of the security data can be verify by the eigenvalue stored in the smart card chip 108.

It should be noted that in the present exemplary embodiment, the storing, the updating and the verifying of security data are explained by taking single security data as an example. However, the invention is not limited thereto, in another exemplary embodiment, when the memory management unit 204 stores a plurality of security data in the flash memory chip 106, the security data protection unit 710 may generate a corresponding signature and a corresponding eigenvalue for each security data, and respectively store the eigenvalues and the signatures in the smart card chip 108 and the flash memory chip 106 for verifying the integrality of each security data. Additionally, in yet another exemplary embodiment, when the memory management unit 204 stores a plurality of security data in the flash memory chip 106, the security data protection unit 710 may generate one signature and one eigenvalue for all the security data and respectively store the eigenvalue and the signature in the smart card chip 108 and the flash memory chip 106 for verifying the integrality of the security data.

In the present exemplary embodiment, the security data protection unit 710 is implemented as firmware codes in the flash memory controller 104 and the microprocessor unit 202 executes the firmware codes. However, the present invention is not limited thereto, and in another exemplary embodiment of the present invention, the control instructions of the security data protection unit 710 are stored in a specific area (for example, the system area of a flash memory chip exclusively used for storing system data) of the flash memory chip 106 as program codes executed by the microprocessor unit 202, or the security data protection unit 710 may also be implemented in the flash memory controller 104 in a hardware form.

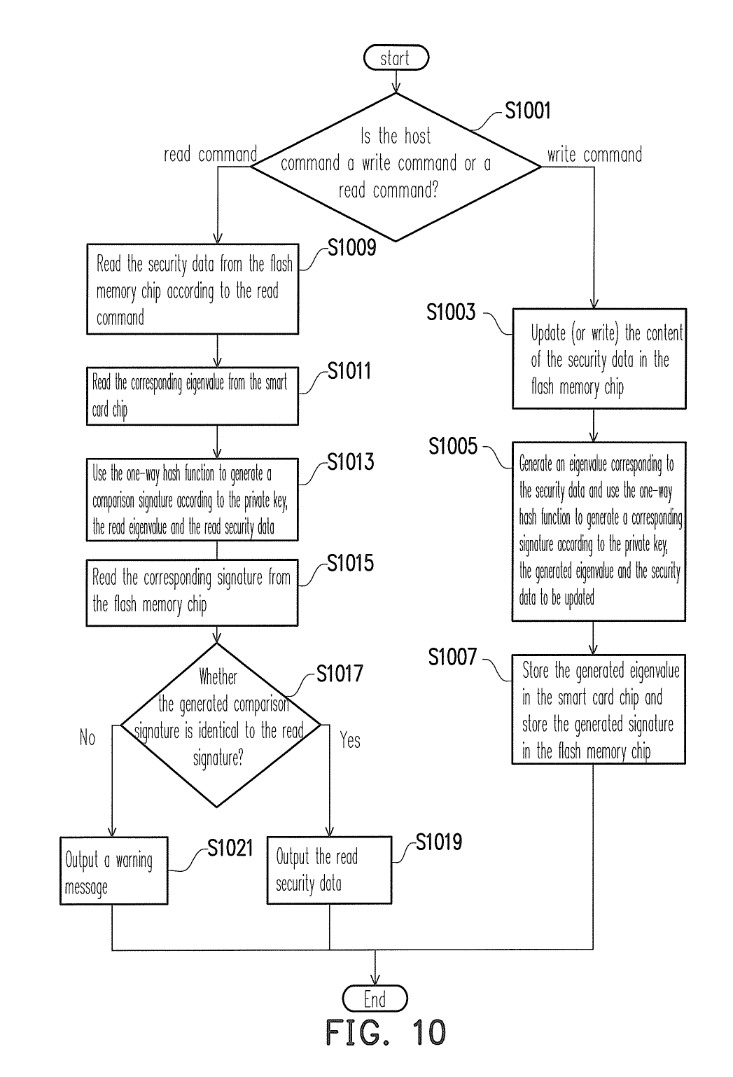

FIG. 10 is a flowchart illustrating an anti-falsifying method according to the second exemplary embodiment of the present invention.

Referring to FIG. 10, when a host command for accessing security data is received, in step S1001, the memory management unit 204 determines whether the host command is a write command or a read command.

When the received host command is the write command, then in step S1003, the memory management unit 204 updates (or writes) the content of the security data in the flash memory chip 106.

After that, in step S1005, the security data protection unit 710 generates an eigenvalue corresponding to the security data and uses the one-way hash function 224 to generate a corresponding signature according to the private key 222, the generated eigenvalue and the security data to be updated. Then, in step S1007, the security data protection unit 710 stores the generated eigenvalue in the smart card chip 108 and stores the generated signature in the flash memory chip 106.

When the received host command is the read command, then in step S1009, the memory management unit 204 reads the security data from the flash memory chip 106 according to the read command.

After that, in step S1011, the security data protection unit 710 reads the corresponding eigenvalue from the smart card chip 108. And, in step S1013, the security data protection unit 710 uses the one-way hash function 224 to generate a comparison signature according to the private key 222, the read eigenvalue and the read security data. And, in step S1015, the security data protection unit 710 reads the corresponding signature from the flash memory chip 106.

Then, in step S1017, the security data protection unit 710 determines whether the generated comparison signature is identical to the read signature. If the generated comparison signature is identical to the read signature, then in step S1019, the memory management unit 204 outputs the read security data to the host system 1000. On the contrary, if the generated comparison signature is not identical to the read signature, then in step S1021, the security data protection unit 710 outputs a warning message to the host system 1000, thereby notifying that the security data has been falsified.

In summary, the flash memory storage apparatus according to the present exemplary embodiment is equipped with the smart card chip and a signature or an eigenvalue corresponding to security data is stored in the flash memory controller chip. Accordingly, the signature or the eigenvalue stored in the smart card chip can be used for verifying the integrality of the security data stored in the flash memory chip. The previously described exemplary embodiments of the present invention have the advantages aforementioned, wherein the advantages aforementioned not required in all versions of the invention.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A flash memory storage system, comprising:
a flash memory controller, having a private key;
a flash memory chip, coupled to the flash memory controller, wherein the flash memory chip stores security data; and
a smart card chip, coupled to the flash memory controller,
wherein the flash memory controller generates a signature corresponding to the security data according to the private key and the security data with a one-way hash function, and stores the signature in the smart card chip.

2. The flash memory storage system according to claim 1,
wherein the flash memory controller reads the security data from the flash memory chip, generates a comparison signature corresponding the read security data according to the private key and the read security data with the one-way hash function, reads the signature from the smart card chip and determines whether the read signature is identical to the generated comparison signature,
wherein the flash memory controller outputs a warning message when the read signature is not identical to the generated comparison signature.

3. The flash memory storage system according to claim 2, wherein the flash memory controller stores updated security data to replace the security data in the flash memory chip,
wherein the flash memory controller generates an updated signature corresponding to the updated security data according to the private key and the updated security data with the one-way hash function, and stores the updated signature to replace the signature in the smart card chip.

4. The flash memory storage system according to claim 1, wherein the smart card chip is a chip complied with a third or higher level of Federal Information Processing Standards (FIPS) 140-2 or a third or higher level of EMV EL.

5. The flash memory storage system according to claim 1, wherein the smart card chip couples to the flash memory controller through an interface, and the interface complies with ISO 7816 standards.

6. A flash memory storage system, comprising:
a flash memory controller, having a private key;
a flash memory chip, coupled to the flash memory controller, wherein the flash memory chip stores security data; and
a smart card chip, coupled to the flash memory controller,
wherein the flash memory controller generates an eigenvalue corresponding to the security data and stores the eigenvalue in the smart card chip,
wherein the flash memory controller generates a signature corresponding to the security data and the eigenvalue according to the private key, the eigenvalue and the security data with a one-way hash function, and stores the signature in the flash memory chip.

7. The flash memory storage system according to claim 6,
wherein the flash memory controller reads the security data and the signature from the flash memory chip, reads the eigenvalue from the smart card chip, generates a comparison signature corresponding the read security data and the read eigenvalue according to the private key, the read eigenvalue and the read security data with the one-way hash function, and determines whether the read signature is identical to the generated comparison signature,
wherein the flash memory controller outputs a warning message when the read signature is not identical to the generated comparison signature.

8. The flash memory storage system according to claim 7, wherein the flash memory controller stores updated security data to replace the security data in the flash memory chip,
wherein the flash memory controller generates an updated eigenvalue corresponding to the updated security data, and generates an updated signature corresponding to the updated security data and the updated eigenvalue according to the private key, the updated eigenvalue and the updated security data with the one-way hash function,
wherein the flash memory controller stores the updated signature to replace the signature in the flash memory chip,
wherein the flash memory controller stores the updated eigenvalue to replace the eigenvalue in the smart card chip.

9. The flash memory storage system according to claim 6, wherein the flash memory controller generates the eigenvalue based on a physical address for storing the security data in the flash memory chip, a random number corresponding to the security data or a counter value corresponding to the security data.

10. A flash memory controller, for protecting security data stored in a flash memory chip, the flash memory controller comprising:
a microprocessor unit;
a flash memory interface unit, coupled to the microprocessor unit, and configured to couple to the flash memory chip;
a memory management unit, coupled to the microprocessor unit; and
a security data protection unit, coupled to the microprocessor unit and has a private key,
wherein the security data protection unit generates a signature corresponding to the security data according to the private key and the security data with a one-way hash function, and stores the signature in the smart card chip.

11. The flash memory controller according to claim 10,
wherein when the memory management unit reads the security data from the flash memory chip, the security data protection unit reads the signature from the smart card chip, generates a comparison signature corresponding the read security data according to the private key and the read security data with the one-way hash function, and determines whether the read signature is identical to the generated comparison signature,
wherein the security data protection unit outputs a warning message when the read signature is not identical to the generated comparison signature.

12. The flash memory controller according to claim 11, wherein the memory management unit stores updated security data to replace the security data in the flash memory chip,
wherein the security data protection unit generates an updated signature corresponding to the updated security data according to the private key and the updated security data with the one-way hash function, and stores the updated signature to replace the signature in the smart card chip.

13. A flash memory controller, for protecting security data stored in a flash memory chip, the flash memory controller comprising:
a microprocessor unit;
a flash memory interface unit, coupled to the microprocessor unit, and configured to couple to the flash memory chip;
a memory management unit, coupled to the microprocessor unit; and
a security data protection unit, coupled to the microprocessor unit and has a private key,
wherein the security data protection unit generates an eigenvalue corresponding to the security data and stores the eigenvalue in a smart card chip,
wherein the security data protection unit generates a signature corresponding to the security data and the eigenvalue according to the private key, the eigenvalue and the security data with a one-way hash function, and stores the signature in the flash memory chip.

14. The flash memory controller according to claim 13,
wherein when the memory management unit reads the security data, the security data protection unit reads the signature from the flash memory chip, reads the eigenvalue from the smart card chip, generates a comparison signature corresponding the read security data and the read eigenvalue according to the private key, the read eigenvalue and the read security data with the one-way hash function, and determines whether the read signature is identical to the generated comparison signature,
wherein the security data protection unit outputs a warning message when the read signature is not identical to the generated comparison signature.

15. The flash memory controller according to claim 14, wherein the memory management unit stores updated security data to replace the security data in the flash memory chip,
wherein the security data protection unit generates an updated eigenvalue corresponding to the updated security data, and generates an updated signature corresponding to the updated security data and the updated eigenvalue according to the private key, the updated eigenvalue and the updated security data with the one-way hash function,
wherein the security data protection unit stores the updated signature to replace the signature in the flash memory chip,
wherein the security data protection unit stores the updated eigenvalue to replace the eigenvalue in the smart card chip.

16. The flash memory controller according to claim 13, wherein the security data protection unit generates the eigenvalue based on a physical address for storing the security data in the flash memory chip, a random number corresponding to the security data or a counter value corresponding to the security data.

17. An anti-falsifying method, for protecting security data stored in a flash memory chip of a flash memory storage system, the anti-falsifying method comprising:
disposing a smart card chip in the flash memory storage system; and
generating a signature corresponding to the security data according to a private key and the security data with a one-way hash function, and storing the signature in the smart card chip.

18. The anti-falsifying method according to claim 17, further comprising:
when the security data is read from the flash memory chip, reading the signature from the smart card chip, generating a comparison signature corresponding the read security data according to the private key and the read security data with the one-way hash function, and determining whether the read signature is identical to the generated comparison signature; and
outputting a warning message when the read signature is not identical to the generated comparison signature.

19. The anti-falsifying method according to claim 18, further comprising:
storing updated security data to replace the security data in the flash memory chip;
generating an updated signature corresponding to the updated security data according to the private key and the updated security data with the one-way hash function; and
storing the updated signature to replace the signature in the smart card chip.

20. An anti-falsifying method, for protecting security data stored in a flash memory chip of a flash memory storage system, the anti-falsifying method comprising:
disposing a smart card chip in the flash memory storage system;
generating an eigenvalue corresponding to the security data and storing the eigenvalue in the smart card chip; and
generating a signature corresponding to the security data and the eigenvalue according to a private key, the eigenvalue and the security data with a one-way hash function, and storing the signature in the flash memory chip.

21. The anti-falsifying method according to claim 20, further comprising:
when the security data is read from the flash memory chip, reading the signature from the flash memory chip, reading the eigenvalue from the smart card chip, generating a comparison signature corresponding the read security data and the read eigenvalue according to the private key, the read eigenvalue and the read security data with the one-way hash function, and determining whether the read signature is identical to the generated comparison signature; and
outputting a warning message when the read signature is not identical to the generated comparison signature.

22. The anti-falsifying method according to claim 21, further comprising:
storing updated security data to replace the security data in the flash memory chip;
generating an updated eigenvalue corresponding to the updated security data;
generating an updated signature corresponding to the updated security data and the updated eigenvalue according to the private key, the eigenvalue and the updated security data with the one-way hash function;
storing the updated signature to replace the signature in the flash memory chip; and
storing the updated eigenvalue to replace the eigenvalue in the smart card chip.

23. The anti-falsifying method according to claim 20, wherein the step of generating the eigenvalue corresponding to the security data comprises: generating the eigenvalue based on a physical address for storing the security data in the flash memory chip, a random number corresponding to the security data or a counter value corresponding to the security data.
